(19) United States
(12) Patent Application Publication
(10) Pub. No.: US 2020/0007278 A1
(43) Pub. Date: Jan. 2, 2020

(54) METHOD AND APPARATUS FOR DYNAMIC CARRIER AGGREGATION CONTROL

(71) Applicant: FORD GLOBAL TECHNOLOGIES, LLC, Dearborn, MI (US)

(72) Inventors: Jeffrey William WIRTANEN, Kanata (CA); Yihai ZHANG, Kanata (CA); Muhammad Khaledul ISLAM, Ottawa (CA)

(21) Appl. No.: 16/025,370

(22) Filed: Jul. 2, 2018

(51) Int. Cl. H04L 5/00; H04W 4/40

(52) U.S. Cl. CPC H04L 5/001; H04W 4/40

(57) ABSTRACT

A system includes a processor configured to receive a data transfer request using a vehicle connectivity option. The processor is also configured to determine whether the request should be fulfilled using carrier aggregation, based on at least a power level powering the connectivity option. The processor is further configured to fulfil the request using or not using carrier aggregation, based at least in part on the results of the carrier aggregation determination.

### TECHNICAL FIELD

The illustrative embodiments generally relate to methods and apparatuses for dynamic carrier aggregation control.

### BACKGROUND

Advances in cellular and wireless technology have provided opportunities for connectivity solutions as part of an in-vehicle experience. Vehicles may leverage a user's cellular device, or the vehicles may use an onboard telematics control unit.

Carrier aggregation is a feature defined by 3^{rd} Generation Partnership project (3GPP) for Long Term Evolution (LTE) network in order to increase available bandwidth to a cellular device which in turn increases data rate. A cellular network provider may have a number of frequencies that can be aggregated to provide an increased allocation of bandwidth. While this improves throughput, this solution also requires more power. Addition of each carrier typically results in 50% to 70% increase in power consumption on cellular device depending on the type of aggregation. Carrier aggregation may comprise consecutive or non-consecutive frequencies (known as component carriers) from a single band or multiple bands; it can be carriers on uplink (known as uplink carrier aggregation or downlink (known as downlink carrier aggregation).

### SUMMARY

In a first illustrative embodiment, a system includes a processor configured to receive a data transfer request using a vehicle connectivity option. The processor is also configured to determine whether the request should be fulfilled using carrier aggregation, based on at least a power level powering the connectivity option. The processor is further configured to fulfil the request using or not using carrier aggregation, based at least in part on the results of the carrier aggregation determination.

In a second illustrative embodiment, a system includes a processor configured to receive a data transfer request. The processor is also configured to determine that a request characteristic corresponds to at least one predefined aggregation characteristic that includes an indication as to whether requests having that characteristic should be fulfilled using carrier aggregation. Also, the processor is configured to fulfil the request based on the aggregation indicated by the predefined aggregation characteristic.

In a third illustrative embodiment, a system includes a processor configured to receive a data transfer request. The processor is also configured to determine that carrier aggregation is appropriate for handling the request, based at least on environmental data corresponding to one or more predefined conditions for using carrier aggregation, and, responsive to the determination, process the request using carrier aggregation.

### BRIEF DESCRIPTION OF THE DRAWINGS

FIG. 1 shows an illustrative vehicle computing system;

FIG. 2 shows an illustrative process for aggregation decision making;

FIG. 3 shows an illustrative process for aggregation request handling;

FIG. 4 shows an illustrative process for aggregation engagement; and

FIG. 5 shows an illustrative process for aggregation based on non-power factors.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

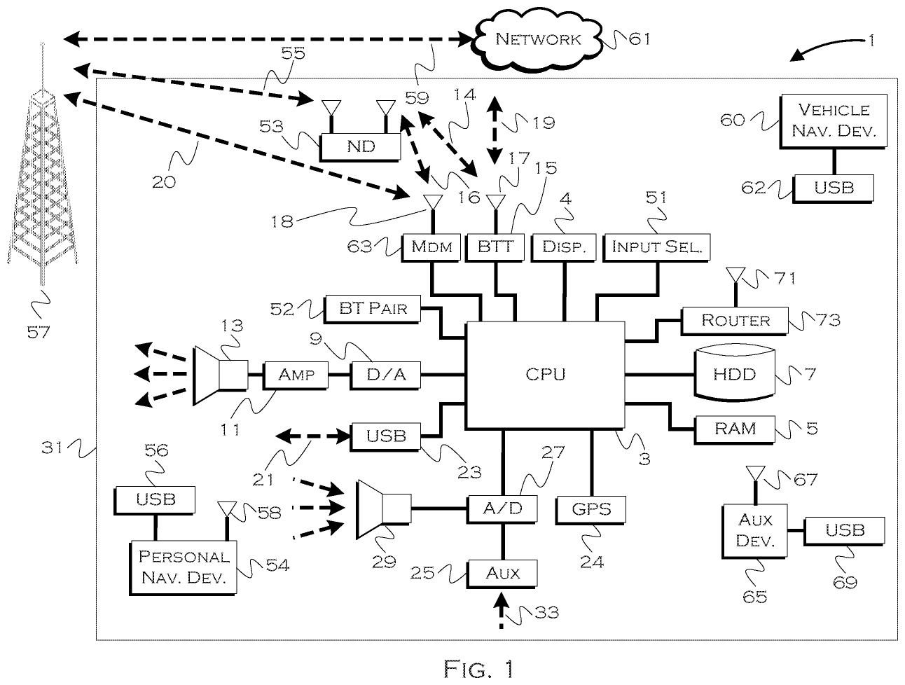

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

The computing system can include a telematics control unit (TCU), which can use an onboard modem or remote, wirelessly connected device, to establish a remote connection to a broader network. The TCU can control, in this example, carrier aggregation according to the examples described and the like. The TCU can be responsible for a variety of telematics-related functions, and is not limited to simply making carrier aggregation decisions.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus or Ethernet) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA), Orthogonal Frequency Division Multiple Access (OFDMA) etc. for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11g network (i.e., Wi-Fi) or a Wi-Max network.

Still further, the vehicle can include an onboard modem that can have carrier aggregation controlled by the TCU as previously discussed. The modem may support communication over various cellular radio access technologies such as GSM, WCDMA, LTE. The modem may provide remote access capabilities and may have its own cellular SIM profile associated therewith. This profile can be used in conjunction with carrier aggregation as discussed herein, to control bandwidth in light of power constraints.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

There are many in-vehicle connectivity solutions where power versus throughput may be considered. For example, if a vehicle is in a low power state, and requires battery power for travel, aggregating carriers may place additional strain on already limited power reserves. In a similar manner, if the vehicle is using a user cellular device for connectivity instead of an onboard modem, the vehicle may desire to limit power usage to as not to fully drain the user device. In this instance, also, carrier aggregation is a trade-off that can be considered in light of a desire to preserve power.

On the other hand, if the vehicle “needs” to use the cellular device to obtain information quickly (immediate navigation data, for example), the power usage may be worth the tradeoff, since the vehicle may be able to function in the absence of a cellular device (i.e., if the request and aggregation to fulfil the request fully drains the cellular device). So, in some instances, the nature of the request may trump a desire to save power.

The illustrative embodiments provide for dynamic carrier aggregation in light of power constraints and consideration, allowing the vehicle or other vehicle-connected device to determine, on a scenario by scenario basis if desired, whether or not to aggregate carriers.

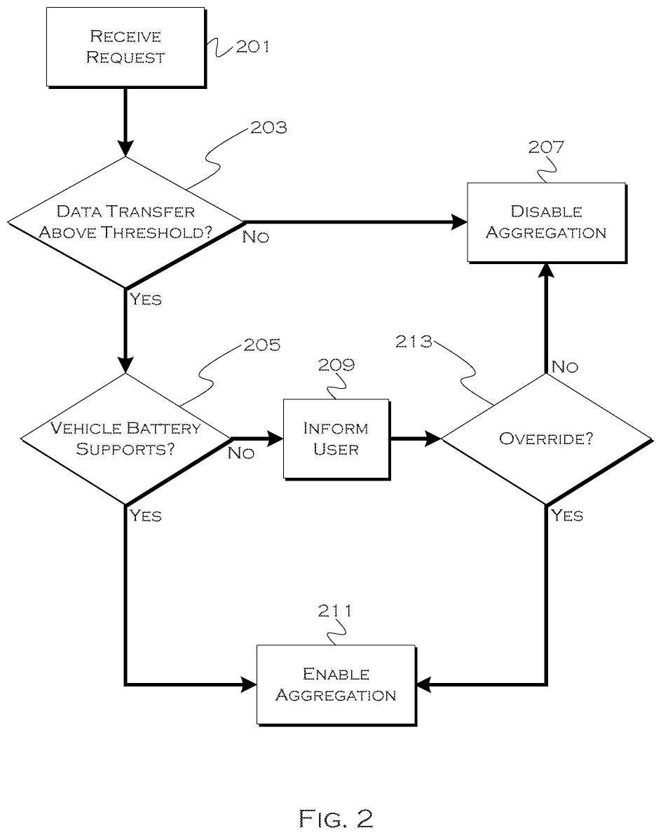

FIG. 2 shows an illustrative process for aggregation decision making. In this illustrative example, the process receives 201 a request that will utilize off-board data transfer. This can be a request from a vehicle system or electronic control unit (ECU), a request from an application, etc. The request can come from an on-board source or a vehicle-connected source (e.g., a cellular device using a vehicle modem for connectivity). Based on a projected volume of data required to service the request, or a requested speed or urgency of data 203, the process may determine whether aggregation is appropriate. The vehicle can self-determine the volume of data or required speed, or the requesting entity can append one or more of these projections or requirements to the request.

In this example, if the data is a “standard” data request that can be easily or appropriately fulfilled without aggregation, the process disables (or doesn't use) 207 aggregation to fulfil the request. This helps keep power usage at a minimum, while still fulfilling the request.

On the other hand, if aggregation is appropriate, the process determines if the vehicle battery 205 can support the likely required amount of power to fulfil the request, without impeding usage of any critical vehicle systems (e.g., successful completion of journey). In a similar manner, were this process executing on or in conjunction with a mobile device, the process could determine if the mobile device battery was going to have sufficient charge to complete the request. A user may have set certain battery minimums, or the “minimum” may be whether or not the battery will be fully drained.

If the battery cannot support the request, the process informs 209 the user that the request could be fulfilled by aggregation, but that a battery (vehicle, phone, etc) may be drained past a recommended point based on request fulfillment. The request may also be attempted in the absence of aggregation, but the process may inform the user that the request may not be completed. If the user elects 213 to override the battery constraint, the process may continue with aggregation 211, in the same manner that the process would have provided aggregation 211 had the battery held sufficient charge to avoid the warning.

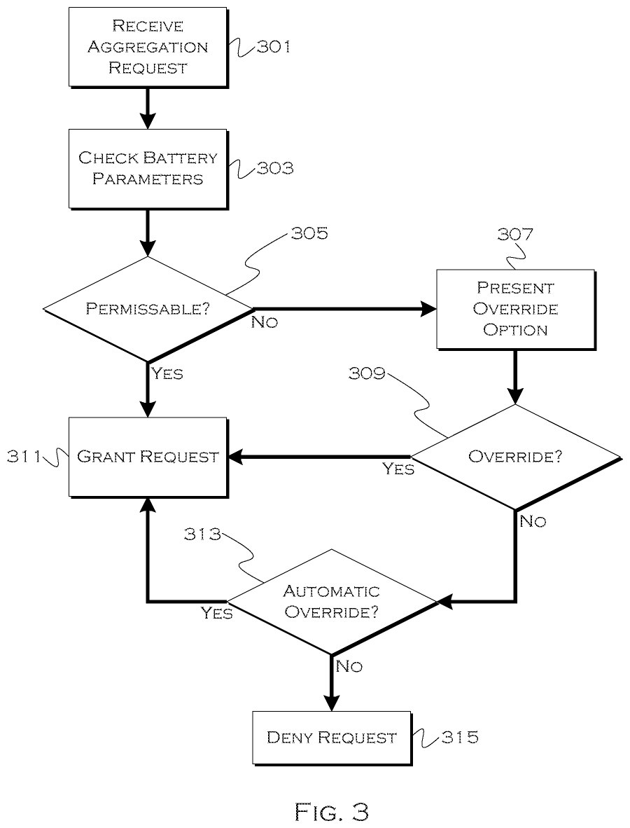

FIG. 3 shows an illustrative process for aggregation request handling. In this illustrative example, the process handles a specific request from an application or telematics unit (or other process) attempting to use carrier aggregation. Thus, if the application, ECU, etc. self-determines that it “needs” aggregation, the request may simply come in the form of a data request with an aggregation instruction. This process can be useful if the determination about the need of aggregation is made elsewhere from where the determination about the permissibility of aggregation is made (e.g., a cell phone requesting to use a vehicle TCU and modem).

Here, the process receives 301 a request to use carrier aggregation. In this example, the process will check 303 the battery parameters of a battery powering the connection, but other parameters may also be considered as discussed later herein. In this example, if the battery life/level is above a predetermined permissible threshold 305, the process can grant 311 the request. The threshold may vary based on request criticality, and may also vary based on the volume of data requested. Further, the consideration may not be a present battery level, but rather a projected battery level following request completion.

In this example, if the battery level is insufficient, the process may present 307 a override option, which can allow a user to specify that a low battery constraint should be overridden 309. If the user elects to override the low battery constraint, the process may grant 311 the request.

Even if the user does not elect to override the battery constraint, the process may have an automatic override 313 which overrides the constraint based on the criticality of the request, or other factors such as those discussed with respect to FIG. 5. If the override does not exist, the request may be denied 315. If the automatic override condition associated with the request or request type is met, the process may grant 311 the aggregation request, despite the battery constraint.

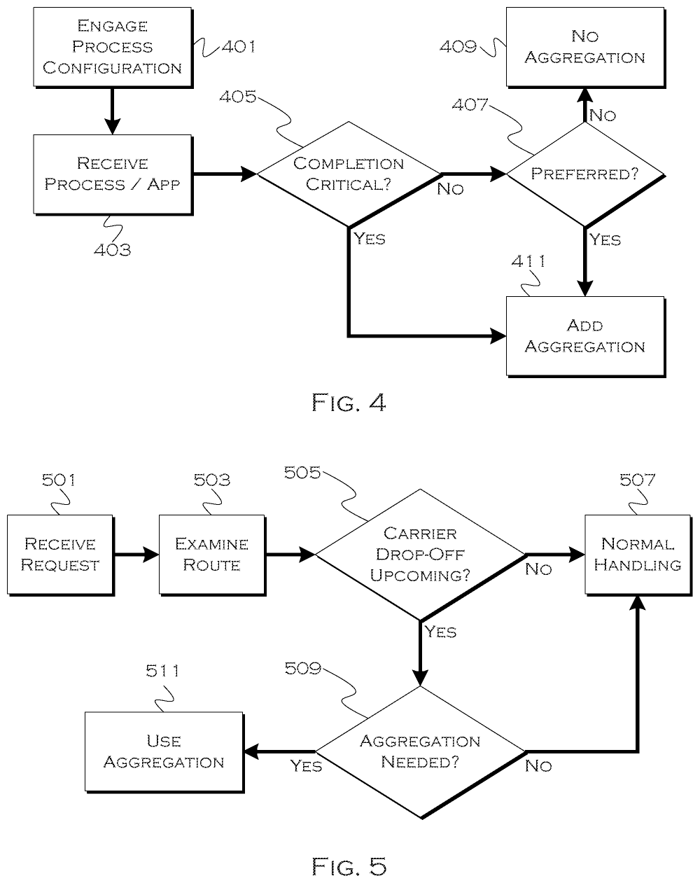

FIG. 4 shows an illustrative process for aggregation engagement. In this illustrative example, the process allows for configuration of override parameters for certain requests or requesting entities, as well as configuration of when aggregation should or should not be applied for those requests or entities. For example, a user could configure “emergency” requests as non-aggregation requests by default, to preserve maximum battery life during a responder situation. In a similar manner, the system could configure system update requests to always use aggregation (these are merely illustrative examples) so that the full update is downloaded as quickly as possible.

If the request completion is a “critical completion” requiring a high likelihood of completion in the shortest amount of time 405, the process may add aggregation 411 as a default setting to fulfil these requests. If the user indicates that aggregation is preferred 407, the process may also add aggregation as a request for the process or request in question. A single process or ECU may have requests of both aggregated and non-aggregated natures associated therewith. If there is not an explicit reason to add aggregation, in this example, the process may default 409 to a no-aggregation setting.

FIG. 5 shows an illustrative process for aggregation based on non-power factors. In this example, an instance of a drop-off in signal strength is considered, but similar factors that could impact transfer completion (e.g., destination arrival and subsequent power-down) could also be considered. Even scenarios that could result in loss of signal (e.g., significant weather or expected high network usage such as at a sporting event) could be the basis for a consideration.

In this example, the process receives 501 a request, and the process examines 503 the upcoming route. In this example, the process has access to a database indicating known areas of signal strength and drop-off (this could be provided by a network provider, crowdsourced, etc.). Crowdsourced data could be used to determine unexpected and real-time network availability, so that one-time signal loss events (sporting events and the like) could be accommodated.

If the process detects 505 a likely carrier drop-off situation, the process can determine if aggregation 509 is needed or likely needed to fulfil the request before a loss of signal occurs. If the aggregation is needed (and/or is permissible), the process may engage 511 aggregation. If the aggregation is not needed, or if there is no projected upcoming loss of signal, the process may use 507 standard handling for that request. Since the process can be enabled to react to dynamic (e.g., crowdsourced) signal changes, the process can engage aggregation as needed, even if an unexpected signal drop is upcoming.

The illustrative embodiments allow for intelligent handling of requests with a consideration of application of carrier aggregation, in a manner that can be reactive to request types, request sizes, request criticality, requesting entity and even environmental changes. This may improve the use of carrier aggregation and allow for improved battery life as well, over a system that simply default aggregates carriers or does not.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

1. A system comprising:
a processor configured to:
receive a data transfer request requesting use of a vehicle connectivity option;
determine whether the request is to be fulfilled using carrier aggregation, based on at least a power remaining in a power source powering the connectivity option, responsive to receiving the request; and
fulfil the request using carrier aggregation, based at least in part on the results of the carrier aggregation determination resulting in a determination that sufficient power remains;
fulfil the request using a single carrier, based at least on part in the results of the carrier aggregation determination resulting in a determination that insufficient power remains;
responsive to determining that insufficient power remains, determine whether a secondary characteristic exists that qualifies the request for a predefined aggregation decision; and
fulfil the request based on the results of the predefined aggregation decision if the aggregation decision indicates a different aggregation usage than the carrier aggregation determination.

2. The system of claim 1, wherein the vehicle connectivity option includes an onboard modem.

3. The system of claim 2, wherein the power level is the power level of a vehicle power supply.

4. The system of claim 1, wherein the vehicle connectivity option includes a wirelessly connected cellular phone providing remote connectivity to the vehicle.

5. The system of claim 4, wherein the power level is the power level of a phone battery.

6. (canceled)

7. The system of claim 1, wherein the secondary characteristic is a request criticality included with the request.

8. The system of claim 1, wherein the secondary characteristic is predefined with respect to an entity from which the request originated, and of which the processor is aware.

9. The system of claim 1, wherein the secondary characteristic is predefined for environmental conditions and is determined by the processor based on environmental conditions.

10. The system of claim 1, wherein the secondary characteristic is predefined for route conditions and is determined by the processor based on current route conditions.

11. A system comprising:
a processor configured to:
receive a data transfer request;
determine that a request characteristic corresponds to at least one predefined aggregation characteristic that indicates that requests having that characteristic are to be fulfilled using carrier aggregation; and
fulfil the request based on the aggregation indicated by the predefined aggregation characteristic, regardless of a power supply level associated with a vehicle connectivity option used to fulfil the request.

12. The system of claim 11, wherein the request characteristic includes a request type.

13. The system of claim 12, wherein the request type includes an emergency services type.

14. The system of claim 12, wherein the request type includes a system critical download type.

15. The system of claim 11, wherein the request characteristic includes a characteristic associated with a request-originating entity, the characteristic associated with the entity being known by the processor.

16. The system of claim 11, wherein the request characteristic includes a projected transfer size.

17. A vehicle comprising:
a processor configured to:
receive a data transfer request;
determine that carrier aggregation is appropriate for handling the request, based at least on environmental data predefined as impacting request completion likelihood corresponding to one or more predefined conditions for using carrier aggregation; and
responsive to the determination, process the request using carrier aggregation.

18. The system of claim 17, wherein the environmental data includes an area of known signal loss projected to be reached by the vehicle before the request is projected to be completed.

19. The system of claim 17, wherein the environmental data includes weather projected to impact signal usability projected to be reached by the vehicle before the request is projected to be completed.

20. The system of claim 17, wherein the environmental data includes a destination projected to be reached by the vehicle before the request is projected to be completed.
